(19) United States
(12) Patent Application Publication
(10) Pub. No.: US 2007/0041376 A1
(43) Pub. Date: Feb. 22, 2007

(54) Method and apparatus for performing tunnel signaling over IP tunneling path

(75) Inventors: Sung-Hyuck Lee, Nam-gu (KR); Jong-Ho Bang, Suwon-si (KR); Henning Schulzrinne, Leonia, NJ (US); Charles-Qi Shen, New York, NY (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignees: Samsung Electronics Co. Ltd; The Trustees of Columbia University

(21) Appl. No.: 11/483,677

(22) Filed: Jul. 11, 2006

Related U.S. Application Data
(60) Provisional application No. 60/697,537, filed on Jul. 11, 2005.

(30) Foreign Application Priority Data
Jun. 9, 2006 (KR) 10-2006-0052104

(51) Int. Cl. H04L 12/56

(52) U.S. Cl. 370/389; 370/401

(57) ABSTRACT

A method and apparatus for performing tunnel signaling over an IP tunneling path connected to an end-to-end path of an IP network where an end-to-end signaling flow from one of a sender and a receiver of the end-to-end path is received, a tunnel signaling flow associated with the IP tunneling path in response to the received end-to-end signaling flow is generated, and the generated tunnel signaling is transmitted.

### CROSS-REFERENCE TO RELATED PATENT APPLICATION

This application claims the benefit under 35 U.S.C. §119(e) of a U.S. provisional patent application Ser. No. 60/697,537, filed on Jul. 11, 2005 in the United States Patent and Trademark Office, and under 35 U.S.C. §119(a) of a Korean patent application No. 10-2006-0052104, filed on Jun. 9, 2006 in the Korean Intellectual Property Office, the entire disclosures of which are hereby incorporated by reference.

### BACKGROUND OF THE INVENTION

1. Field of the Invention

The present invention relates to a method of performing tunnel signaling over an IP tunneling path. More particularly, the present invention relates to a method of performing tunnel signaling by generating and transmitting a tunnel signaling flow corresponding to an end-to-end signaling flow over an IP tunneling path.

2. Description of the Related Art

As Internet technologies have spread, a next-generation communication network is being developed as an “all-IP” network having a structure to which Internet Protocol (IP)-based core networks and various access networks are integrated. In the all-IP network, a wired network such as public switched telephone network (PSTN) and a wireless network supporting International Mobile Telecommunication-2000 (IMT-2000) are linked to the IP-based core network to function as one integrated IP network.

Integration of different types of networks frequently occurs between a network supporting an IP version 6 (IPv6) address system used for supporting mobility and quality-of-service (QoS), and a conventional IP version 4 (IPv4) network, as well as between an IP network and a non-IP network. Accordingly, a network linking technology for providing Internet service integrated by an entire network including a network apparatus supporting IPv4 and a network apparatus supporting IPv6 is required.

An IP tunneling technology has been in the spotlight as a technology for performing the integration between an IP network and a non-IP network or IP networks of different types. IP tunneling indicates an encapsulation method of transmitting a packet via a virtual pipe between two nodes on a network. A packet transmission path between two nodes is called an IP tunneling path or an IP tunnel. Packets transmitted over the IP tunneling path comprise conventional data packet and a signaling packet including a signaling message for performing particular operations such as QoS and resource reservation.

Typically, a conventional data packet is transmitted over the IP tunneling path by adding a tunnel IP header to a data packet in a suitable form according to a type of a network forming the IP tunneling path. For example, when an IPv6 data packet passes an IP tunneling path operating according to an IPv4 protocol, an IPv4 header including addresses of both end points of the IP tunneling path is added to the IPv6 data packet.

However, the described method has an aspect not suitable for transmitting a signaling packet forming a signaling message associated with maintaining and managing a network. Specifically, according to the described method, it is not possible to reflect an operation associated with the signaling message on the IP tunneling path by dealing with a signaling packet as a conventional data packet. For example, since information associated with operations of reserving network resources to perform QoS with respect to an IP tunneling path and transferring a router alert option or a certain protocol number is encapsulated by a tunnel IP header, it is not shown on nodes on the IP tunneling path. Therefore, the described signaling operations may not be performed over the IP tunneling path.

In addition, as in the case of one of the conventional QoS methods, when classifying a data packet transmitted over an IP tunneling path according to a service flow type corresponding to the data packet and to a schedule for each type, if an IP packet transmitted over the IP tunneling path is encapsulated by a tunnel IP header, the service flow type is not recognized on the IP tunneling path. Therefore, the described signaling operations may not be suitably performed.

On the other hand, a User Datagram Protocol (UDP) header may be added for recognizing a QoS data packet on a tunneling path. However, since the UDP header is relatively large, there is a considerable increase in overhead by adding the UDP header to all packets passing the IP tunneling path. Particularly, this type of tunneling method is not suitable since the overhead due to adding the UDP header becomes larger with respect to a service of transmitting a small packet, such as voice over IP (VoIP).

On the other hand, there has been disclosed a method of recognizing an encapsulated message on an IP tunneling path by encapsulating a packet using a Security Parameters Index (SPI) field of an IP Security (IPSEC) protocol proposed by the Internet Engineering Task Force (IETF) for secure transmission and reception of packets in an IP layer. According to this method, a fine signaling over an IP tunneling path is possible without any overhead due to adding an additional header. However, the method can be applied to only an IP tunneling path supporting the IPSEC protocol.

A conventional resource reservation protocol (RSVP) using the described methods of adding an IP header or a UDP header to an IP packet, or using an IPSEC SPI field cannot effectively support mobility of a host, since the conventional RSVP does not support sender-initiated signaling that will be described later, and does not have consideration for the mobility, for example, a session identifier value varies with hand-off of a mobile node.

Accordingly, there has been an increased interest in a tunnel signaling method for effectively performing tunnel signaling over an IP tunneling path and supporting mobility and QoS is increasing.

Therefore, there is a need for an improved apparatus and method for providing Internet service integrated by an entire network including a network apparatus supporting IPv4 and a network apparatus supporting IPv6.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method of effectively processing a data packet and a signaling packet on an IP tunneling path.

An aspect of exemplary embodiments of the present invention is also to provide a method of recognizing a tunnel signaling message on an IP tunneling path by generating a tunnel signaling flow separated from an end-to-end signaling flow and transmitting the tunnel signaling flow over the Internet Protocol (IP) tunneling path.

An aspect of exemplary embodiments of the present invention is also to provide a method of supporting tunnel signaling without an additional packet overhead.

An aspect of exemplary embodiments of the present invention is also to provide a tunnel signaling method of effectively supporting mobility of a host.

According to an aspect of exemplary embodiments of the present invention, a method of performing tunnel signaling over an IP tunneling path connected to an end-to-end path of an IP network is provided. The method comprises receiving an end-to-end signaling flow from one of a sender and a receiver of the end-to-end path. A tunnel signaling flow associated with the IP tunneling path in response to the received end-to-end signaling flow is generated. The generated tunnel signaling flow over the IP tunneling path is transmitted.

According to another aspect of exemplary embodiments of the present invention, an apparatus performing tunnel signaling over an IP tunneling path is provided. The apparatus comprises an end-to-end interface for transmitting and receiving an end-to-end signaling flow over an end-to-end path connected to the IP tunneling path, a tunnel interface for transmitting and receiving a tunnel signaling flow over the IP tunneling path, a tunnel signaling performance unit for performing an operation associated with a tunnel signaling message included in the tunnel signaling flow by referring to the tunnel signaling message, and a tunnel signaling control unit for generating the tunnel signaling flow corresponding to the end-to-end signaling flow.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and/or other aspects and advantages of certain exemplary embodiments of the present invention will become apparent and more readily appreciated from the following detailed description, taken in conjunction with the accompanying drawings, in which:

FIG. 1 is a diagram illustrating a network to which a tunnel signaling method is applied according to an exemplary embodiment of the present invention;

FIG. 2 is a flowchart illustrating the tunnel signaling method according to an exemplary embodiment of the present invention;

FIG. 3 is a flowchart illustrating sub-operations for forming the operation of generating a tunnel signaling flow shown in FIG. 2;

FIG. 4 is a diagram illustrating a configuration of a tunnel data object applied to a tunnel signaling method according to an exemplary embodiment of the present invention;

FIG. 5 is a diagram illustrating a message flow between network apparatuses for sender-initiated sequential signaling according to an exemplary embodiment of the present invention;

FIG. 6 is a diagram illustrating a message flow between network apparatuses for sender-initiated parallel signaling according to another exemplary embodiment of the present invention;

FIG. 7 is a diagram illustrating a message flow between network apparatuses for sender-initiated sequential signaling according to still another exemplary embodiment of the present invention;

FIG. 8 is a diagram illustrating a message flow between network apparatuses for sender-initiated parallel signaling according to yet another exemplary embodiment of the present invention;

FIG. 9 is a configuration diagram illustrating a reverse tunneling structure in a mobile IP environment, according to an exemplary embodiment of the present invention;

FIG. 10 is a configuration diagram illustrating a forward tunneling structure in a mobile IP environment, according to another exemplary embodiment of the present invention;

FIGS. 11 and 12 are diagrams illustrating a process of searching a signaling flow aware node over an IP tunneling path according to an exemplary embodiment of the present invention;

FIG. 13 is a block diagram illustrating an internal configuration of a network apparatus including a tunnel signaling function, according to an exemplary embodiment of the present invention; and

FIG. 14 is a block diagram illustrating an internal configuration of a tunnel signaling control unit of FIG. 13 according to an exemplary embodiment of the present invention.

Throughout the drawings, the same reference numerals will be understood to refer to the same elements, features, and structures.

### DETAILED DESCRIPTION OF EXEMPLARY EMBODIMENTSS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

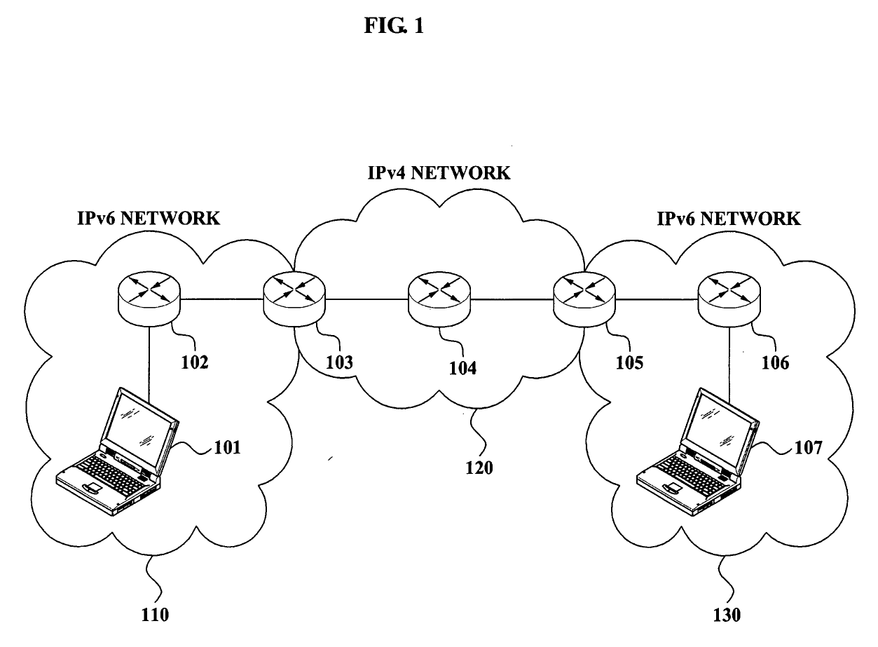

FIG. 1 is a diagram illustrating a network to which a tunnel signaling method according to an exemplary embodiment of the present invention is applied. A configuration of an entire network formed of an end-to-end path operating according to an IP version 6 (IPv6 ) protocol, and an Internet Protocol (IP) tunneling path according to an IP version 4 (IPv4 ) protocol is schematically illustrated. Referring to FIG. 1, an IP tunneling path 120 may comprise a tunnel entry node 103 for making a packet transmitted from a sender 101 of end-to-end paths 110 and 130 flow into the IP tunneling path 120, a tunnel exit node 105 for making the packet transferred over the IP tunneling path 120 be transmitted to a receiver 107 of the end-to-end paths 110 and 130, and at least one intermediate node 104 for transferring a data packet or a signaling packet between the tunnel entry node 103 and the tunnel exit node 105.

In exemplary configuration of the present invention, though end-to-end paths supporting an IPv6 protocol and an IP tunneling path supporting an IPv4 protocol are shown in FIG. 1, end-to-end paths and an IP tunneling path to which an exemplary embodiment of the present invention is applied may comprise networks supporting the IPv4 or IPv6, respectively. In addition, it is obvious to those skilled in the art that an exemplary embodiment of the present invention can be applied to all kinds of different IP networks such as a mobile IPv4, a mobile IPv6, and others, in which end-to-end paths and an IP tunneling path operate base on IP.

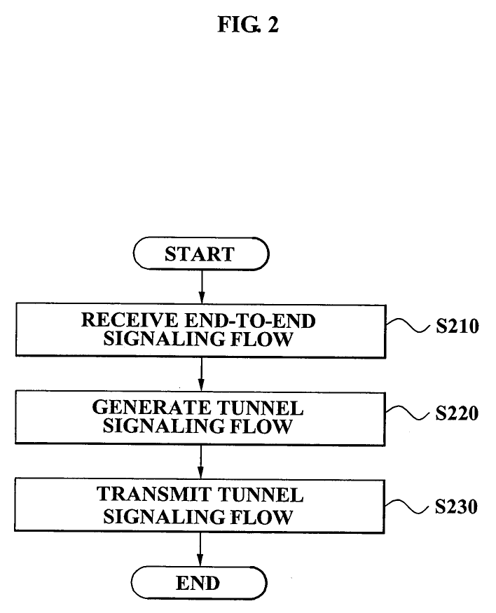

FIG. 2 is a flowchart illustrating a method of performing tunnel signaling over the described IP tunneling path, according to an exemplary embodiment of the present invention.

Referring to FIG. 2, an end-to-end signaling flow is received at step S210. The received end-to-end signaling flow may be received from the sender 101 over the end-to-end path 110 or may be received from the receiver 107 over the end-to-end path 130.

For example, “signaling flow” indicates a series of packets including a signaling message, and “signaling message” indicates a message transmitted between network elements to perform signaling. In an exemplary embodiment of the present invention, the term “signaling” refers to a conventional process of interchanging control information with respect to operations and management of a network apparatus in addition to conventional data between the network elements and may comprise Internet quality-of-service (QoS), operations associated with reservation, change, and release of network resources, or exchange of control information associated with network security. Hereinafter, in an exemplary embodiment of the present invention, “signaling” will be substantially described from a QoS and resource reservation point of view. However, an exemplary embodiment of the present invention is applied over the length and breadth of the conventional meaning of signaling and is not limited to the exemplary embodiments which will be described below.

The term “Signaling flow” mentioned to describe the construction and operations of an exemplary embodiment of the present invention may refer to an end-to-end signaling flow or a tunnel signaling flow. The end-to-end signaling flow indicates a signaling flow transmitted between the sender 101 and the receiver 107 forming a network end over the end-to-end paths 110 and 130. A broad meaning of an end-to-end path indicates an entire network path connecting the sender 101 to the receiver 107. However, in an exemplary embodiment of the present invention, an end-to-end path is limited to designate paths excluding an IP tunneling path from the entire network path.

On the other hand, a tunnel signaling flow indicates a signaling flow transmitted between the tunnel entry node 103 and the tunnel exit node 105 of the IP tunneling path 120 over the IP tunneling path 120. To properly provide an end-to-end service, a signaling message has to be processed in nodes 103, 104, and 105 on the IP tunneling path 120 as well as nodes 102 and 106 on an end-to-end path. However, since the IP tunneling path 120 comprises a network different from the end-to-end paths 110 and 130, an end-to-end signaling flow cannot be directly processed. Accordingly, a tunnel signaling flow transmitted to the nodes 103, 104, and 105 on the IP tunneling path over the IP tunneling path in response to the end-to-end signaling flow received at step S210 and capable of being recognized by the nodes 103, 104, and 105 is generated at step S220.

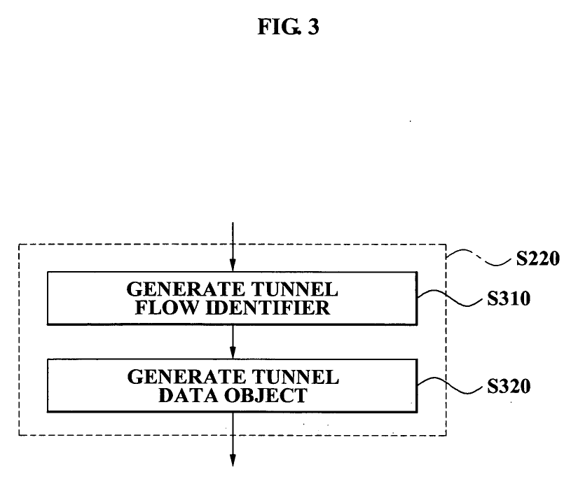

FIG. 3 is a flowchart illustrating sub-operations forming the operation of generating a tunnel signaling flow at step S220 shown in FIG. 2. Referring to FIG. 3, a tunnel flow identifier respectively given to each generated tunnel signaling flow is generated at step S310. Since the tunnel signaling flow is transmitted over the IP tunneling path 120, the tunnel signaling flow comprises correspondence information with the end-to-end signaling flow to perform end-to-end signaling. Accordingly, at step S320, a tunnel data object storing the tunnel flow identifier of the tunnel signaling flow and the correspondence information with the end-to-end signaling flow is generated.

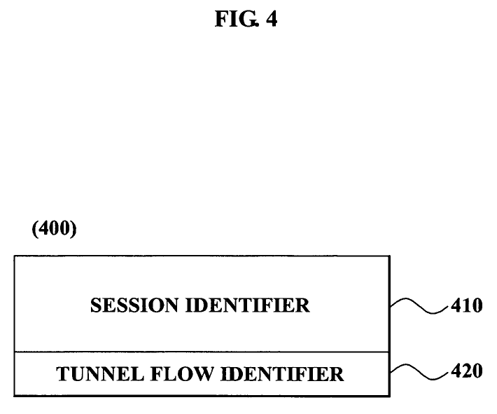

FIG. 4 is a diagram illustrating a field configuration of a tunnel data object 400 generated at step S320. Referring to FIG. 4, the tunnel data object 400 comprises a session identifier field 410 for storing a session identifier value and a tunnel flow identifier field 420 for storing a tunnel flow identifier. The session identifier whose value is stored in the session identifier field 410 represents the end-to-end signaling flow corresponding to the tunnel signaling flow including the tunnel data object 400. Namely, the session identifier is a unique identifier of a service session associated with the end-to-end signaling flow, and functions to identify the end-to-end signaling flow transmitted to support an effective provision of a service based on end-to-end connection.

The tunnel flow identifier stored together with the session identifier is a unique identifier of the tunnel signaling flow and is updated or newly generated when a change in the configuration of the IP tunneling path, such as a change of the tunnel entry node 103 or the tunnel exit node 105, occurs. Namely, unlike the session identifier where the value is maintained identically while an end-to-end service session is maintained, the tunnel flow identifier may vary with address information of the IP tunneling path.

In the tunnel signaling method according to an exemplary embodiment of the present embodiment, seamless signaling may be smoothly provided end-to-end in an environment in which mobility of a terminal has to be secured, such as a portable Internet system supporting mobile IP, by distinguishing the session identifier from the tunnel flow identifier to separate the end-to-end signaling flow and the tunnel signaling flow. Application of an exemplary embodiment of the present invention in a mobile IP environment will be described later in detail.

Also, unlike a conventional tunneling method applied to a conventional data flow, the tunnel signaling method according to an exemplary embodiment of the present invention may enable a signaling message to be recognized by each node on an IP tunneling path without increasing packet overhead such as an additional User Datagram Protocol (UDP) header. Particularly, in the tunnel signaling method according to an exemplary embodiment of the present invention, a high quality service may be provided by reducing packet overhead and supporting an end-to-end quality-of-service (QoS) in association with a multimedia application service as a form suitable for multimedia application.

At step S320, the session identifier and the tunnel flow identifier, distinguished from each other, are stored in a single tunnel data object 400 as the correspondence information between the end-to-end signaling flow and the tunnel signaling flow, thereby effectively connecting an IP tunneling signaling with an end-to-end signaling.

According to an exemplary embodiment of the present invention, the tunnel flow identifier 420 of the tunnel data object 400 may be selected from a data field list including a plurality of data field candidates.

For example, a Differentiated Service Code Point (DSCP) field of an IP header of an IP packet for forming the tunnel signaling flow may be selected as the tunnel flow identifier field 420. The DSCP field is used for providing a differentiated service type QoS and is commonly included in IPv4 and IPv6. Accordingly, the DSCP field may be broadly applied to various IP tunneling paths.

On the other hand, a flow label of IPv6 may be selected as the tunnel flow identifier field 420 storing the tunnel flow identifier. Since the flow label to which a greater number of bits than the DSCP field are allocated, more tunnel signaling flows can be transmitted over an IP tunneling path. Accordingly, when an IP tunneling path supports IPv6, tunnel signaling may be effectively performed by using an IPv6 flow label.

As described above, the tunnel flow identifier is stored in a data field selected with reference to at least one of the IP header of the end-to-end signaling flow, a kind of a network for forming the IP tunneling path, and a type of a service associated with the end-to-end signaling flow, and is transmitted together with a source address and a destination address to at least one of the nodes on the IP tunneling path, thereby performing the tunnel signaling.

For example, the source address and the destination address may be an address of a tunnel entry node or a tunnel exit node.

On the other hand, when the DSCP field and the IPv6 flow label are not supported, an SPI of an IPSEC header or a UDP header may be selected as the tunnel flow identifier field 420.

Referring to FIG. 2, at step S230, the tunnel signaling flow generated at step S220 is transmitted over the IP tunneling path, thereby performing the tunnel signaling. The tunnel signaling according to an exemplary embodiment of the present invention is divided into several types depending on the tunnel signaling flow transmitted at step S230 or a method of transmitting the tunnel signaling message included in the tunnel signaling flow.

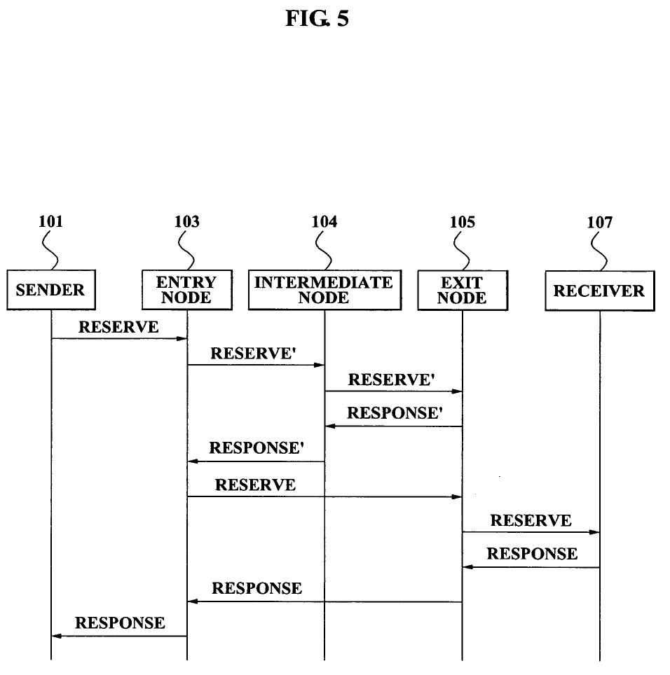

Hereinafter, a detailed process of the transmitting the tunnel signaling flow will be described with reference to FIGS. 5 through 8, for certain exemplary embodiments. For example, below, the tunnel signaling message and the end-to-end signaling message are resource reservation messages. However, the signaling message of an exemplary embodiment of the present invention is not limited to the network resource reservation message.

Accordingly, in the description below, the term “tunnel resource reservation message RESERVE” can be referred to by a more conventional term “tunnel signaling message”, “tunnel resource reservation response message RESPONSE” by “tunnel signaling response message”, and “tunnel resource reservation query message QUERY” by “tunnel signaling query message”, to be applied as is to conventional tunnel signaling.

The tunnel signaling method according to an exemplary embodiment of present invention supports a sender-initiated signaling and receiver-initiated signaling. The sender-initiated signaling indicates that a tunnel resource reservation message RESERVE′ is transmitted from the tunnel entry node 103 receiving an end-to-end resource reservation message RESERVE, to the tunnel exit node 105. The receiver-initiated signaling indicates that the tunnel resource reservation message RESERVE′ is transmitted from the tunnel exit node 105 to the tunnel entry node 103 to perform resource reservation of the IP tunneling path.

On the other hand, the tunnel signaling method is divided into sequential signaling and parallel signaling, depending on an order of the transmitting the tunnel signaling flow at step S230 and forwarding the end-to-end signaling flow between the tunnel entry node 103 and the tunnel exit node 105. The sequential signaling indicates case in which the forwarding waits its operation until the tunnel signaling flow is sent. The parallel signaling indicates that the forwarding is performed simultaneously with transmitting the tunnel signaling flow.

As described above, according to the two references, an exemplary embodiment of the present invention supports tunnel signaling modes in various forms, different from each other. Each of the signaling modes will be described with reference to FIGS. 5 though 8.

FIG. 5 is a diagram illustrating a message flow between network apparatuses for sender-initiated sequential signaling according to an exemplary embodiment of the present invention. Referring to FIG. 5, the tunnel entry node 103 receives the end-to-end resource reservation message RESERVE from the sender 101, generates the tunnel resource reservation message RESERVE′ corresponding to the received end-to-end resource reservation message RESERVE, and transmits the tunnel resource reservation message RESERVE′ to the tunnel exit node 105 via the intermediate node 104 on the IP tunneling path.

The tunnel exit node 105 for receiving the tunnel resource reservation message RESERVE′ transmits the tunnel resource reservation response message RESPONSE′ including a resource reservation result to the tunnel entry node 103 via the intermediate node 104. Until the resource reservation signaling over the IP tunneling path is completed via the described sequential processes, the end-to-end resource reservation message RESERVE waits in the tunnel entry node 103.

The tunnel entry node 103 for receiving the tunnel resource reservation response message RESPONSE′ from the tunnel exit node 105 forwards the end-to-end resource reservation message RESERVE to the tunnel exit node 105 to enable the end-to-end resource reservation message RESERVE to be transmitted and processed from the tunnel exit node 105 to the receiver 107 via the end-to-end path. The receiver 107 for receiving the end-to-end resource reservation message RESERVE transmits an end-to-end resource reservation response message RESPONSE including a result of reserving resource on the end-to-end path, to the tunnel exit node 105. The tunnel exit node 105 forwards the received end-to-end resource reservation response message RESPONSE to the tunnel entry node 103 and enables the end-to-end resource reservation response message RESPONSE to be transmitted from the tunnel entry node 103 to the sender 101 over the end-to-end path.

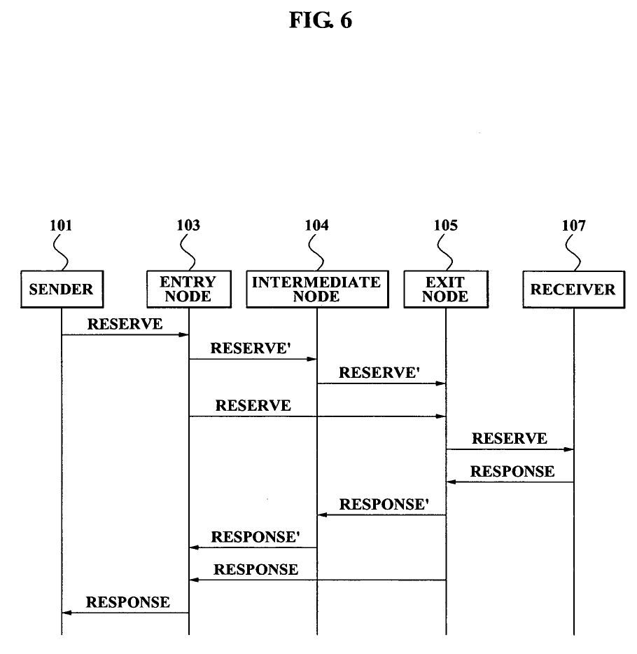

FIG. 6 is a diagram illustrating a message flow between network apparatuses for sender-initiated parallel signaling according to another exemplary embodiment of the present invention.

Referring to FIG. 6, forwarding the end-to-end resource reservation message RESERVE received from the sender 101 from the tunnel entry node 103 to the tunnel exit node 105 may be performed simultaneously with transmitting the tunnel resource reservation message RESERVE′ generated by the tunnel entry node 103 in response to the end-to-end resource reservation message RESERVE to the tunnel exit node 105 via the intermediate node 104.

The end-to-end resource reservation message RESERVE forwarded from the tunnel entry node 103 is transmitted from the tunnel exit node 105 to the receiver 107 over the end-to-end path. When the end-to-end resource reservation response message RESPONSE generated by the receiver 107 in response to receiving the end-to-end resource reservation message RESERVE is transmitted to the tunnel exit node 105, the tunnel exit node 105 receiving the end-to-end resource reservation response message RESPONSE transmits the tunnel resource reservation response message RESPONSE′ simultaneously with the transmitting the end-to-end resource reservation response message RESPONSE to the tunnel entry node 103, to be parallel to each other. Specifically, forwarding the end-to-end resource reservation response message RESPONSE is performed simultaneously with transmitting the tunnel resource reservation response message RESPONSE′. The end-to-end resource reservation response message RESPONSE forwarded from the tunnel exit node 105 is transmitted from the tunnel entry node 103 to the sender 101 over the end-to-end path.

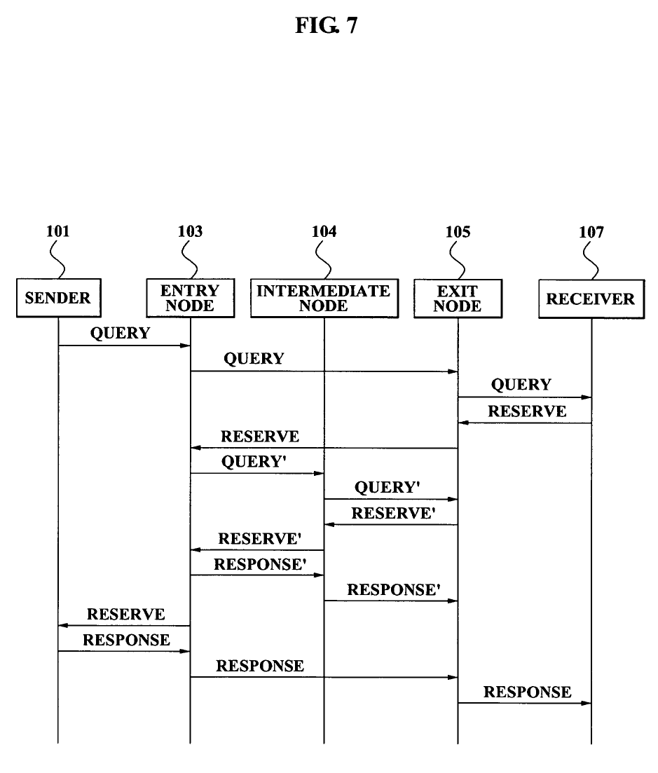

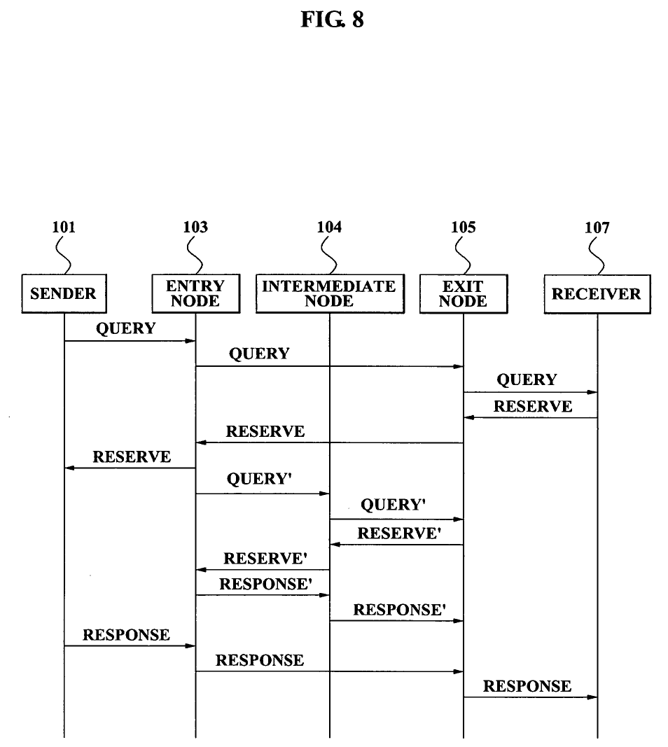

Unlike the sender-initiated signaling shown in FIGS. 5 and 6, in which the resource reservation message and the resource reservation response message are used, in receiver-initiated signaling shown in FIGS. 7 and 8, a resource reservation query message is used as well.

FIG. 7 is a diagram illustrating a message flow between network apparatuses for sender-initiated sequential signaling according to still another exemplary embodiment of the present invention.

Referring to FIG. 7, the sender 101 transmits an end-to-end resource reservation query message QUERY to the tunnel entry node 103 over the end-to-end path. The tunnel entry node 103 forwards the received end-to-end resource reservation query message QUERY to the tunnel exit node 105 to be set to the receiver 107. The receiver 107 for receiving the end-to-end resource reservation query message QUERY over the end-to-end path transmits the end-to-end resource reservation message RESERVE to the tunnel exit node 105.

The end-to-end resource reservation message RESERVE is forwarded from the tunnel exit node 105 to the tunnel entry node 103. The tunnel entry node 103 generates a tunnel resource reservation query message QUERY′ corresponding to the end-to-end resource reservation message RESERVE and transmits the generated tunnel resource reservation query message QUERY′ to the tunnel exit node 105 via the intermediate node 104. The tunnel exit node 105 receiving the tunnel resource reservation query message QUERY′ generates and transmits the tunnel resource reservation message RESERVE′ to the tunnel entry node 103 via the intermediate node 104. The tunnel entry node 103 transmits the tunnel resource reservation response message RESPONSE′ generated in response to the tunnel resource reservation message RESERVE′ to the tunnel exit node 105 via the intermediate node 104.

When the resource reservation signaling with respect to the IP tunneling path is completed via the described series of processes, the end-to-end resource reservation message RESERVE waiting in the tunnel entry node 103 is transmitted from the tunnel entry node 103 to the sender 101 via the end-to-end path. The sender 101 transmits the end-to-end resource reservation response message RESPONSE including a result of reserving end-to-end resource to the tunnel entry node 103. The tunnel entry node 103 forwards the received end-to-end resource reservation response message RESPONSE to the tunnel exit node 105 to be transmitted to the receiver 107 over the end-to-end path.

FIG. 8 is a diagram illustrating a message flow between network apparatuses for sender-initiated parallel signaling according to yet another exemplary embodiment of the present invention.

In the signaling shown in FIG. 8, as well as the signaling shown in FIG. 7, the end-to-end resource reservation query message QUERY transmitted from the sender 101 to the tunnel entry node 103 over the end-to-end path is forwarded to the tunnel exit node 105 and is transmitted from the tunnel exit node 105 to the receiver 107. Also, the end-to-end resource reservation message RESERVE transmitted from the receiver 107 in response to the end-to-end resource reservation query message QUERY is forwarded from the tunnel exit node 105 to the tunnel entry node 103.

However, unlike the signaling shown in FIG. 7, transmitting the end-to-end resource reservation message RESERVE from the tunnel entry node 103 to the receiver 107 is performed simultaneously with the exchanging tunnel signaling messages over the IP tunneling path. Also, parallel to the transmitting of the end-to-end resource reservation message RESERVE, the tunnel resource reservation query message QUERY′ generated by the tunnel entry node 103 is transmitted to the tunnel exit node 105 via the intermediate node 104. The tunnel resource reservation message RESERVE′ generated by the tunnel exit node 105 in response to the tunnel resource reservation query message QUERY′ is transmitted to the tunnel entry node 103 via the intermediate node 104. The tunnel entry node 103 transmits the tunnel resource reservation response message RESPONSE′ including a tunnel resource reservation result to the tunnel exit node 105 via the intermediate node 104.

While the resource reservation signaling on the IP tunneling path is performed via the described processes, the end-to-end resource reservation response message RESPONSE including a result of resource reservation over the end-to-end path connecting the sender 101 to the tunnel entry node 103 is transmitted from the sender 101 to the tunnel entry node 103. The tunnel entry node 103 forwards the end-to-end resource reservation response message RESPONSE to the tunnel exit node 105 before transmitting the described tunnel resource reservation response message RESPONSE′ to the tunnel exit node 105 is completed.

The tunnel exit node 105 for receiving the forwarded end-to-end resource reservation response message RESPONSE transmits the end-to-end resource reservation response message RESPONSE to the receiver 107 over the end-to-end path connecting the tunnel exit node 105 to the receiver 107, thereby completing the end-to-end resource reservation signaling.

As described above with reference to FIGS. 5 through 8, in the tunnel signaling method according to an exemplary embodiment of the present invention, a network configuration of various IP tunneling paths and end-to-end paths may be supported by supporting signaling modes different from each other.

Particularly, as shown by comparing FIGS. 5 and 6 with FIGS. 7 and 8, the sender-initiated signaling provides resource reservation signaling faster and simpler than the receiver-initiated signaling. A broadly used resource reservation protocol (RSVP) supports the receiver-initiated signaling. An exemplary embodiment of the present invention may reduce state management complexity and signaling delay, compared with a conventional tunneling method based on the RSVP.

Also, as shown by comparing FIG. 6 with FIG. 8 and comparing FIG. 5 with FIG. 7, respectively, signaling speed is enhanced with the parallel signaling due to a short waiting time for exchanging signaling messages. However, when resource reservation on the IP tunneling path fails, success of network resource reservation on an entire end-to-end path connecting a sender to a receiver is not secured. However, when a length of an IP tunneling path is relatively shorter than a length of the end-to-end tunneling path or whether the success of the network resource reservation on the IP tunneling path does not have a great effect on a quality of providing an end-to-end service, the parallel signaling having a high speed may be preferred.

As described above, an exemplary embodiment of the present invention for supporting the sender-initiated signaling and the parallel signaling provides an exceptionally suitable tunnel signaling method for a mobile IP environment. Specifically, when a tunnel entry node or a tunnel exit node of an IP tunneling path is changed according to a relocation of a terminal, it is required to minimize tunnel signaling overhead to effectively maintain a service session. According to an exemplary embodiment of the present invention, overhead due to resource reservation and QoS establishment may be minimized.

For example, when the tunnel signaling is performed by the parallel signaling mode, an end-to-end signaling flow forwarded between the tunnel entry node 103 and the tunnel exit node 105 does not comprise information associated with whether the tunnel signaling on the IP tunneling path succeeds. Accordingly, to determine whether the tunnel entry node 103 or the tunnel exit node 105, for receiving the forwarded end-to-end signaling flow, waits until the tunnel signaling is completed, minimum information is required. For this, when operating in the parallel signaling mode, the tunnel entry node 103 or the tunnel exit node 105, for forwarding the end-to-end signaling flow, may perform the forwarding after establishing a predetermined flag value indicating that QoS may not be secured because performing the tunnel signaling with respect to the end-to-end signaling flow is not complete. Accordingly, the tunnel entry node 103 or the tunnel exit node 105, for receiving the forwarded end-to-end signaling flow, may refer to the established flag value and may transmit the end-to-end signaling flow over the end-to-end path simultaneously with performing the tunnel signaling when the flag value is established.

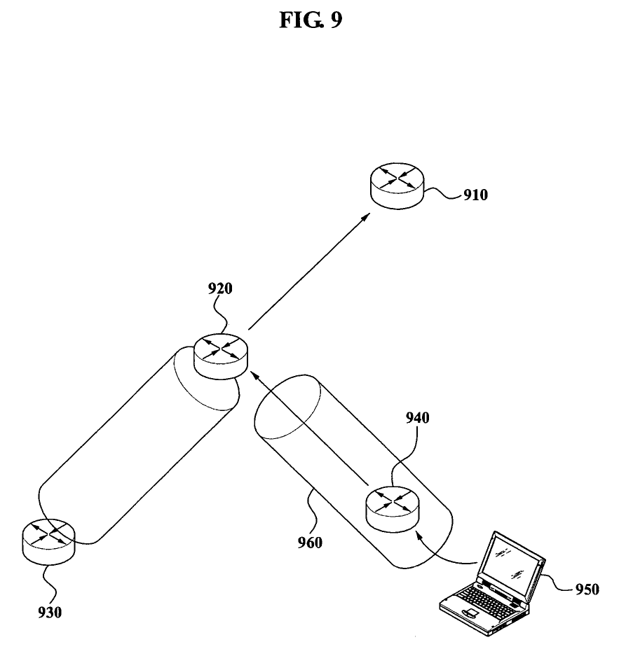

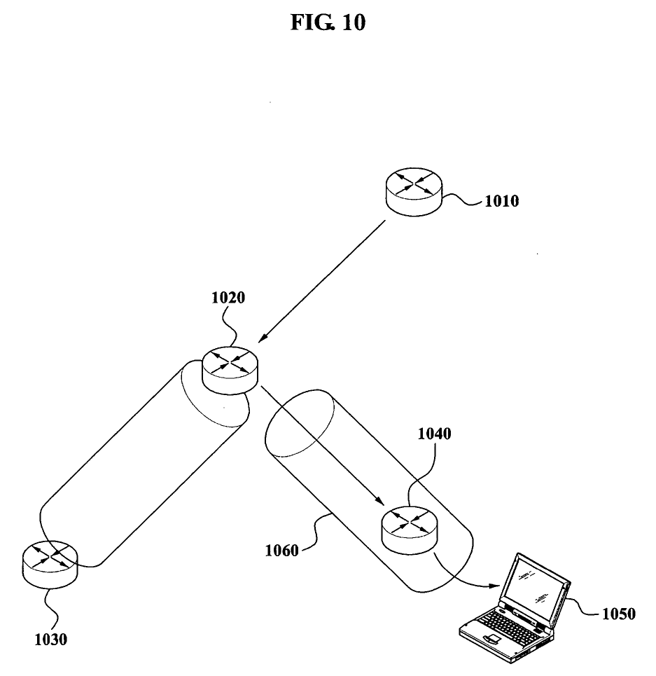

FIGS. 9 and 10 are diagrams illustrating an IP tunneling path according to an exemplary embodiment of the present invention supporting a mobile IP. In detail, FIG. 9 is a configuration diagram illustrating a reverse tunneling structure. For example, the mobile IP environment to which the tunnel signaling method according to an exemplary embodiment of the present invention is applied may comprise mobile IPv4, mobile IPv6, and other various kinds of IP environments supporting mobility with respect to IP.

Referring to FIG. 9, an entire network for supporting the mobile IP may comprise a mobile node 950 of a mobile terminal, a home agent 920 connected to a home network of the mobile node 950 to give and manage a home address that is a unique address of the mobile node 950, access routers 930 and 940 for connecting the mobile node 950 to a network, and a correspondence node 910 for performing end-to-end communication with the mobile node 950.

In the mobile IPv4, a foreign agent giving a care-of-address to the mobile node 950 and transferring the care-of-address to the home agent 920 when the mobile node 950 is out of the home network and accesses an external network is required. However, for simplicity of description, the foreign agent will not be additionally mentioned with respect to an exemplary embodiment of the present invention.

In FIG. 9, the mobile node 950 connected to the old access router 930 included in the home network is out of the home network and is connected to a new access router 940 included in the external network. A change in location of the mobile node 950 may occur in a handoff of a mobile communication terminal. When an end-to-end path between the mobile node 950 and the correspondence node 910 is configured within different IP networks, establishment of an IP tunneling path is required for providing an end-to-end service, and a tunnel signaling method has to be provided to perform resource reservation on the IP tunneling path.

Referring to FIG. 9, when a network path connecting the mobile node 950 to the home agent 920 is established as the IP tunneling path 960 and the tunnel signaling is performed according to a reverse tunneling method in which the tunneling is initiated by the mobile node 950, the mobile node 950 becomes the tunnel entry node 103 of the IP tunneling path 960 as well as the sender 101, and the correspondence node 910 becomes the receiver 107. The home agent 920 becomes the tunnel exit node 105 of the IP tunneling path 960.

Accordingly, as the mobile node 950 changes a connection point from the old access router 930 to the new access router 940, the tunnel entry node 103 of the IP tunneling path becomes changed. As described above, according to the tunnel signaling method according to an exemplary embodiment of the present invention, when the tunnel entry node 103 of the IP tunneling path is changed, a new tunnel signaling flow is generated as well as a tunnel flow identifier becomes changed. However, though the tunnel flow identifier is changed, a session identifier associated with the end-to-end signaling flow is not changed, thereby maintaining continuity of the end-to-end service session.

Also, a header for the tunnel signaling on the IP tunneling path is not added, thereby minimizing packet overhead. Also, fast tunnel signaling is provided in the mobile IP environment in which a change in the IP tunneling path is relatively frequent, by supporting the parallel signaling mode and the sender-initiated signaling mode, thereby effectively managing with service delay caused in a handoff situation.

Also, when the IP tunneling path 960 is established between the mobile node 950 and the home agent 920 as shown in FIG. 9, reservation of network resources between the home agent 920 and the correspondence node 910 may be not duplicated when the network resource reservation has to be performed again because the IP tunneling path 960 changes due to handoff. Also, a problem of service delay that may occur due to performing unnecessary resource reservation may be mitigated.

Referring to FIG. 9, the mobile node 950 generates and transmits a tunnel signaling flow to the home agent 920 over the IP tunneling path 960 to perform the tunnel signaling. At the same time, the mobile node 950 forwards an end-to-end signaling flow to the home agent 920 for signaling over an end-to-end path between the home agent 920 and the correspondence node 910. The forwarding the end-to-end signaling flow may be performed after the transmitting the tunnel signaling flow or may be performed parallel with the transmitting the tunnel signaling flow. The home agent 920 receiving the end-to-end signaling flow may determine whether to transmit the end-to-end signaling flow to the correspondence node 910 before the tunnel signaling is completed, by referring to a flag value included in the end-to-end signaling flow.

FIG. 10 is a configuration diagram illustrating a forward tunneling structure in a mobile IP environment. Unlike the embodiment shown in FIG. 9, in FIG. 10, a tunnel signaling is initiated by the correspondence node 1010 when the mobile node 1050 is connected to the external network after a handoff. In this case, when mobile node 1050 changes connection point between access routers 1030 and 1040, the mobile node 1050 becomes the receiver 107 as well as the tunnel exit node 105 of an IP tunneling path 1060, and the correspondence node 1010 becomes the sender 101. A home agent 1020 becomes the tunnel entry node of the IP tunneling path 1060.

In this case, the home agent generates a tunnel signaling flow in response to an end-to-end signaling flow transmitted from the correspondence node 1010 to the home agent 1020. Since a change occurring in the mobile node 1050 is updated at the home agent 1020, the signaling flow generated by the home agent 1020 is transmitted to a new address of the mobile node 1050 over the new IP tunneling path 1060.

According to the exemplary embodiments of the present invention described with reference to FIGS. 9 and 10, a tunnel signaling path after a handoff of the mobile node 950 and 1050 is limited to a path between the mobile node 950 and 1050 and the home agent 920 and 1020, thereby minimizing a waste of time and physical resource according to a tunnel signaling. Also, by supporting bidirectional tunneling, triangle routing that may occur in association with the mobile IPv4 and an ingress filtering error in which a packet transmitted from a mobile node is determined to be a unauthorized packet and is blocked by a node located on an optimized route when route optimization is applied in the mobile IPv6, may be effectively overcome.

In an exemplary implementation, in the reverse tunneling mode, since tunnel signaling is instantly initiated from the mobile node 950 when the IP tunneling path is changed, the continuity of a service session may be more surely provided, thereby effectively supporting the mobile IP environment.

On the other hand, the tunnel signaling method may further comprise searching for a tunnel signaling aware node recognizing a tunnel signaling flow on an IP tunneling path. When the described searching for a node is added, the described various signaling modes may be effectively supported. For example, when tunnel signaling and end-to-end signaling are performed by the sender-initiated signaling mode, only the tunnel entry node 103 has to recognize the tunnel signaling flow. However, when a tunnel signaling is performed by the receiver-initiated signaling mode, since a tunnel signaling flow is generated at the tunnel exit node 105, the tunnel entry node 103 and the tunnel exit node 105 have to recognize the tunnel signaling flow. In actuality, the tunnel entry node 103 and the tunnel exit node 105 may not always comprise a function of recognizing the tunnel signaling flow, so that the tunnel entry node 103 and the tunnel exit node 105 have to discover the tunnel signaling aware node capable of recognizing the tunnel signaling flow on the IP tunneling path.

In an exemplary implementation, the searching for a tunnel signaling aware node may comprise transmitting a discovery message for verifying tunnel signaling awareness, to at least one node located on the IP tunneling path, and receiving a discovery response message transmitted from the at least one node located on the IP tunneling path in response to the discovery message.

The searching a tunnel signaling aware node is a kind of pre-processing for performing signaling. Since nodes on an IP tunneling path cannot recognize an end-to-end signaling flow, an end-to-end discovery message applied to the nodes on an end-to-end path has to be also newly formed and transmitted as a tunnel discovery message, with respect to the nodes on the IP tunneling path as well as a tunnel signaling flow is generated and sent.

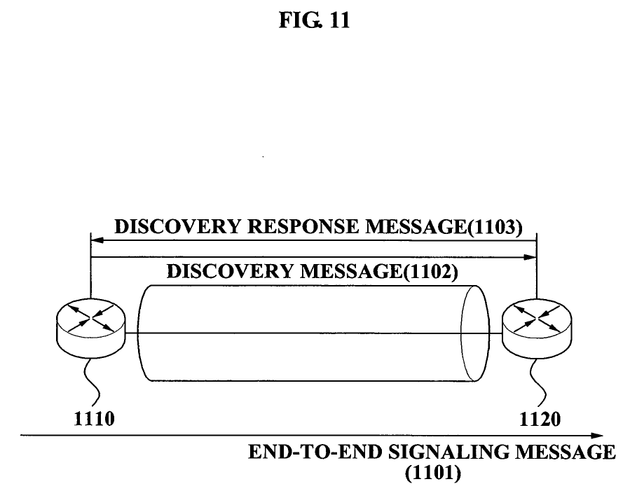

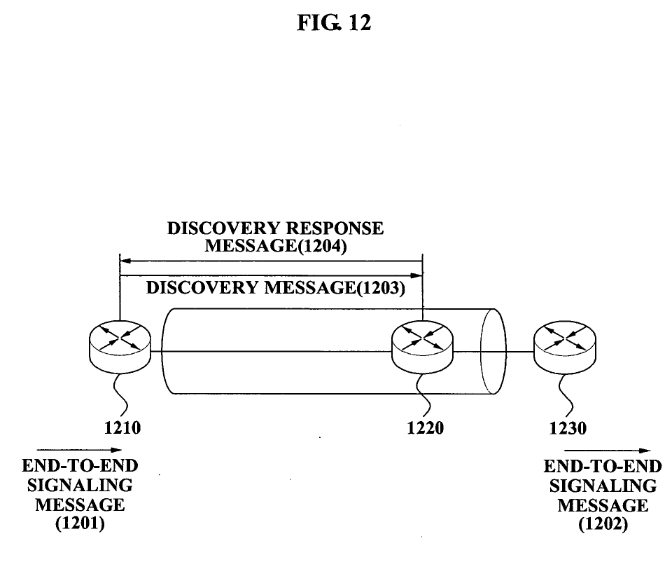

FIGS. 11 and 12 are diagrams illustrating a process of exchanging a discovery message and a discovery response message to discover a tunnel signaling aware node over an IP tunneling path according to an exemplary embodiment of the present invention.

In FIG. 11, a tunnel exit node 1120 is the tunnel signaling aware node. In this case, a node search process may be performed parallel to an end-to-end signaling process. Specifically, an end-to-end signaling message 1101 may be forwarded over an IP tunneling path before a procedure of transmitting a discovery message 1102 from a tunnel entry node 1110 to the tunnel exit node 1120 and receiving a discovery response message 1103 sent back from the tunnel exit node 1120 at the tunnel entry node 1103 is completed.

FIG. 12 is a diagram illustrating a situation where a tunnel exit node 1230 is not the tunnel signaling aware node. In this case, the node search process is performed prior to the end-to-end signaling process. As shown in FIG. 12, when the tunnel exit node 1230 is not a tunnel signaling aware node, the tunnel exit node 1230 receives a discovery response message 1204 from a tunnel signaling aware node 1220 searched on the IP tunneling path by means of the discovery message 1203.

In this case, since the tunnel exit node 1230 is not a tunnel signaling aware node, a process of forwarding an end-to-end signaling message 1201 received by a tunnel entry node 1210 to the tunnel exit node 1230 may not be performed simultaneously with the node search process. Accordingly, in this case, when the node search process is completed, an end-to-end signaling message 1202 forwarded to the tunnel exit node 1230 is transmitted to a receiver.

The method of performing tunnel signaling over an IP tunneling path, according to an exemplary embodiment of the present invention, may be embodied as a program instruction capable of being executed via various computer units and may be recorded in a computer-readable recording medium. The computer-readable medium may comprise a program instruction, a data file, and a data structure, separately or cooperatively. The program instructions and the media may be those specially designed and constructed for the purposes of an exemplary embodiment of the present invention, or they may be of the kind well known and available to those skilled in the art of computer software arts. Examples of the computer-readable media comprise magnetic media (for example, hard disks, floppy disks, and magnetic tapes), optical media (for example, CD-ROMs or DVD), magneto-optical media (for example, optical disks), and hardware devices (for example, ROMs, RAMs, or flash memories, and so on) that are specially configured to store and perform program instructions. The media may also be transmission media such as optical or metallic lines, wave guides, and so on, including a carrier wave transmitting signals specifying the program instructions, data structures, and so on. Examples of the program instructions comprise both machine code, such as produced by a compiler, and files containing high-level language codes that may be executed by the computer using an interpreter. The hardware elements above may be configured to act as one or more software modules for implementing the operations of an exemplary embodiment of the present invention.

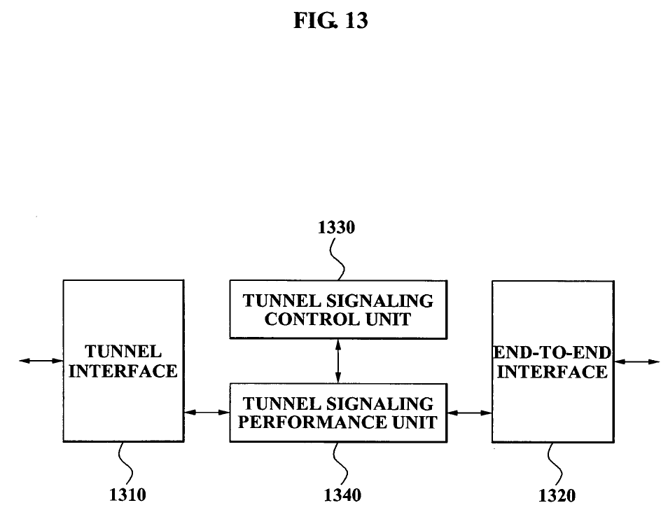

An exemplary embodiment of the present invention is applied to a network apparatus performing tunnel signaling over an IP tunneling path. FIG. 13 is a block diagram illustrating an internal configuration of a network apparatus including a tunnel signaling function, according to an exemplary embodiment of the present invention.

A tunnel interface 13 10 shown in FIG. 13 is an element of the network apparatus, for transmitting and receiving a tunnel signaling flow over an IP tunneling path. The tunnel interface 1310 connects the network apparatus according to an exemplary embodiment of the present invention to the IP tunneling path.

On the other hand, an end-to-end interface 1320 transmits and receives an end-to-end signaling flow over an end-to-end path and connects the network apparatus according to an exemplary embodiment of the present invention to the end-to-end path. When the network apparatus is located in the tunnel entry node 103, the end-to-end interface 1320 transmits a data flow or the end-to-end signaling flow to the sender 101 or receives the data flow or the end-to-end signaling flow from the sender 101. On the other hand, when the network apparatus is located on the tunnel exit node 105, the end-to-end interface 1320 transmits the data flow or the end-to-end signaling flow to the receiver 107 or receives the data flow or the end-to-end signaling flow from the receiver 107.

The tunnel interface 1310 and the end-to-end interface 1320 may comprises a network interface including a function of processing a data flow or a signaling flow according to any one of address systems from IPv4, IPv6, mobile IPv4, and mobile IPv6, respectively.

A tunnel signaling performance unit 1340 performs a suitable signaling operation according to a signaling message included in the tunnel signaling flow. For example, the tunnel signaling performance unit 1340 may comprise a logic extracting the signaling message, a logic analyzing the signaling message, and a logic updating QoS information and resource reservation information of the network apparatus according to the signaling message.

A tunnel signaling control unit 1330 controls the tunnel interface 1310, the end-to-end interface 1320, and the tunnel signaling performance unit 1340.

Also, the tunnel signaling control unit 1330 generates a tunnel signaling flow corresponding to the end-to-end signaling flow received via the end-to-end interface 1320, for signaling over the IP tunneling path. For this, the tunnel signaling control unit 1330 has an internal configuration as follows.

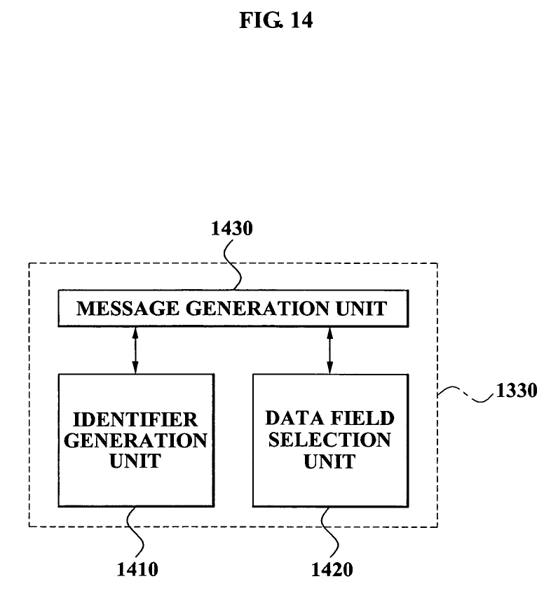

FIG. 14 is a block diagram illustrating the internal configuration of the tunnel signaling control unit 1330 of FIG. 13.

As shown in FIG. 14, the tunnel signaling control unit 1330 may comprise an identifier generation unit 1410, a data field selection unit 1420, and a message generation unit 1430. Hereinafter, operations and functions of the described elements will be described in detail.

A tunnel signaling flow is an IP packet including a signaling message identical to a signaling message included in an end-to-end signaling flow and has a packet configuration capable of being transmitted over the IP tunneling path 120. Accordingly, the message generation unit 1430 generates a tunnel signaling message that will be transmitted over the IP tunneling path, as the tunnel signaling flow. Also, the message generation unit 1430 stores a tunnel flow identifier uniquely given to the generated tunnel signaling message in a predetermined data field.

For example, the tunnel signaling message comprises a QoS message associated with QoS over an IP tunnel path, a network resource reservation message reserving, changing, or releasing network resource required in performing the QoS, and a network security message indicating an operation over the IP tunneling path, associated with security of a data flow transmitted over the IP tunneling path.

On the other hand, the identifier generation unit 1410 generates the described tunnel flow identifier in response to the tunnel signaling message, and the data selection unit 1420 selects a data field storing the tunnel flow identifier from a data field list including a plurality of data field candidates.

The plurality of data field candidates capable of being selected may be a DSCP field included in an IP header of each IP packet forming an end-to-end signaling flow or a flow label of an IPv6 header when the tunnel signaling flow is formed of the IPv6 packet.

The network apparatus according to an exemplary embodiment of the present invention may comprise a wireless network device such as an access control router (ACR) and a network device such as gateway GPRS support node (GGSN) in addition to a router and terminal operating in a wired IP network.

As described above, the network apparatus including IP tunnel signaling function, according to an exemplary embodiment of the present invention has been described with reference to FIGS. 13 and 14. Since the detailed contents of the exemplary implementation previously described with reference to FIGS. 1 through 12 may be applied to the network apparatus according to an exemplary embodiment of the present invention, description of detailed content associated with the present network apparatus will be omitted for clarity and conciseness.

According to an aspect of exemplary embodiments of the present invention, a tunnel signaling flow distinguished from an end-to-end signaling flow is generated and transmitted over an IP tunneling path, thereby recognizing a tunnel signaling message on the IP tunneling path. Accordingly, operations according to a signaling message can be performed over the IP tunneling path as well as over an end-to-end path, thereby providing veritable end-to-end signaling.

Also, according to an aspect of exemplary embodiments of the present invention, a tunnel flow identifier uniquely given to a tunnel signaling flow is stored in a predetermined data object together with a corresponding session identifier, thereby providing integrated signaling with respect to an entire network by connecting an end-to-end signaling flow to the tunnel signaling flow.

Also, according to an aspect of exemplary embodiments of the present invention, a data field storing a tunnel flow identifier is selected from a plurality of data fields capable of being selected, thereby performing adaptable tunnel signaling control according to a kind of network, traffic condition, or service application.

Also, according to an aspect of exemplary embodiments of the present invention, a flow identifier and a session identifier are stored in a data field included in a tunnel signaling flow, thereby supporting tunnel signaling without additional packet overhead.

Also, according to an aspect of exemplary embodiments of the present invention, a value of a session identifier is identically maintained when handoff of a mobile node supporting an mobile IP occurs while a service session is continued, thereby effectively supporting mobility of a host.

Also, according to an aspect of exemplary embodiments of the present invention, sender-initiated tunnel signaling is supported as well as receiver-initiated tunnel signaling, thereby providing a more suitable signaling method for an IP tunneling path supporting a mobile IP.

Also, according to an aspect of exemplary embodiments of the present invention, parallel performance of transmitting an end-to-end signaling flow and transmitting a tunnel signaling flow is supported as well as sequential performance of transmitting an end-to-end signaling flow and transmitting a tunnel signaling flow, thereby providing a more suitable signaling method for an IP tunneling path supporting a mobile IP.

Also, according to an aspect of exemplary embodiments of the present invention, a tunnel discovery message may be supported to be transmitted sequential or parallel to an end-to-end discovery message to discover a tunnel signaling aware node, thereby effectively discover the tunnel signaling aware node.

Although a few exemplary embodiment of the present invention have been shown and described with reference to certain exemplary embodiments thereof, it will be understood by those skilled in the art that various changes in form and details may be made therein without departing from the principles and spirit of the present invention as defined by the appended claims and their equivalents.

What is claimed is:

1. A method for performing tunnel signaling over an Internet Protocol (IP) tunneling path connected to an end-to-end path of an IP network, the method comprising:
receiving an end-to-end signaling flow from at least one of a sender and a receiver of the end-to-end path;
generating a tunnel signaling flow associated with the IP tunneling path in response to the received end-to-end signaling flow; and
transmitting the generated tunnel signaling flow over the IP tunneling path.

2. The method of claim 1, wherein the generating of the tunnel signaling flow comprises:
generating a tunnel flow identifier corresponding to the tunnel signaling flow; and
generating a tunnel data object for storing correspondence relation information between the generated tunnel flow identifier and the end-to-end signaling flow.

3. The method of claim 2, wherein the generating of the tunnel flow identifier comprises selecting a data field for storing the tunnel flow identifier from a data field list comprising a plurality of data field candidates.

4. The method of claim 3, wherein the data field list comprises at least one of a Differentiated Service Code Point (DSCP) field of an Internet Protocol (IP) header, a flow label of an IP version 6 (IPv6 ) header, a Security Parameters Index (SPI) of an IP Security (IPSEC) header, and a User Datagram Protocol (UDP) header.

5. The method of claim 3, wherein the selecting of the data field comprises selecting the data field by referring to at least one of an IP header of the end-to-end signaling flow, a network type of the IP tunneling path, and a type of service associated with the end-to-end signaling flow.

6. The method of claim 2, wherein the correspondence relation information comprises the tunnel flow identifier and a session identifier of a service session associated with the end-to-end signaling flow.

7. The method of claim 6, wherein the session identifier is maintained to be a same value while the service session is being continued.

8. The method of claim 1, wherein the transmitting of the generated tunnel signaling flow comprises:
transmitting a tunnel signaling message from a tunnel entry node of the IP tunneling path to a tunnel exit node of the IP tunneling path; and
transmitting a tunnel signaling response message from the tunnel exit node to the tunnel entry node, in response to the tunnel signaling message.

9. The method of claim 1, wherein the transmitting of the generated tunnel signaling flow comprises:
receiving an end-to-end signaling message from at least one of the receiver and the sender;
transmitting a tunnel signaling query message from a tunnel entry node of the IP tunneling path to a tunnel exit node of the IP tunneling path, in response to the end-to-end signaling message;
transmitting a tunnel signaling message from the tunnel exit node to the tunnel entry node, in response to the tunnel signaling query message; and
transmitting a tunnel signaling response message from the tunnel entry node to the tunnel exit node, in response to the tunnel signaling message.

10. The method of claim 1, further comprising forwarding the end-to-end signaling flow between a tunnel entry node and a tunnel exit node of the IP tunneling path,
wherein the forwarding is delayed until the tunnel signaling is completed.

11. The method of claim 1, further comprising forwarding the end-to-end signaling flow between a tunnel entry node and a tunnel exit node of the IP tunneling path,
wherein the forwarding is performed simultaneously with the tunnel signaling.

12. The method of claim 11, wherein the forwarding comprises setting up a flag value for indicating that the tunnel signaling has not been completed, in association with the end-to-end signaling flow, and that one of the tunnel entry node and the tunnel exit node for receiving the forwarded end-to-end signaling flow determines whether to transmit the end-to-end signaling flow over the end-to-end path by referring to the flag value.

13. The method of claim 1, wherein the tunnel signaling comprises one of a quality-of-service (QoS) signaling, a network resource reservation signaling, and a network security signaling.

14. The method of claim 1, wherein the IP tunneling path comprises one of an IP version 4 (IPv4 ) network and an IP version 6 (IPv6 ) network.

15. The method of claim 1, wherein the IP tunneling path comprises a mobile IP tunneling path connecting a mobile node to a home agent supporting a mobile IP.

16. The method of claim 15, wherein the tunnel signaling is initiated by at least one of the home agent and the mobile node.

17. The method of claim 15, wherein the mobile IP comprises one of a mobile IP version 4 (IPv4 ) and a mobile IP version 6 (IPv6 ).

18. The method of claim 1, further comprising searching for a tunnel signaling aware node over the IP tunneling path.

19. The method of claim 18, wherein the searching comprises:
transmitting a discovery message for checking tunnel signaling awareness, to at least one node located on the IP tunneling path; and
receiving a discovery response message transmitted from the at least one node located on the IP tunneling path in response to the discovery message.

20. The method of claim 19, wherein the discovery message is transmitted from a tunnel entry node of the IP tunneling path to a tunnel exit node of the IP tunneling path.

21. The method of claim 18, further comprising forwarding the end-to-end signaling flow associated with signaling over the end-to-end path between a tunnel entry node and a tunnel exit node of the IP tunneling path,
wherein the forwarding is initiated before the searching is completed.

22. The method of claim 18, further comprising forwarding the end-to-end signaling flow associated with signaling over the end-to-end path between a tunnel entry node and a tunnel exit node of the IP tunneling path,
wherein the forwarding is delayed until the searching is completed.

23. A computer-readable recording medium in which a program for executing a method of performing tunnel signaling over an IP tunneling path connected to an end-to-end path of an IP network is recorded, the medium comprising:
a first set of instructions for receiving an end-to-end signaling flow from at least one of a sender and a receiver of the end-to-end path;
a second sent of instructions for generating a tunnel signaling flow associated with the IP tunneling path in response to the received end-to-end signaling flow; and
a third set in instructions for performing the tunnel signaling by transmitting the generated tunnel signaling flow over the IP tunneling path.

24. An apparatus performing tunnel signaling over an Internet Protocol (IP) tunneling path, the apparatus comprising:
an end-to-end interface for transmitting and receiving an end-to-end signaling flow over an end-to-end path connected to the IP tunneling path;
a tunnel interface for transmitting and receiving a tunnel signaling flow over the IP tunneling path;
a tunnel signaling performance unit for performing an operation associated with a tunnel signaling message included in the tunnel signaling flow by referring to the tunnel signaling message; and
a tunnel signaling control unit for generating the tunnel signaling flow corresponding to the end-to-end signaling flow.

25. The apparatus of claim 24, wherein the tunnel signaling control unit comprises:
an identifier generation unit for generating a tunnel flow identifier corresponding to the tunnel signaling flow;
a data field selection unit for selecting a data field storing the generated tunnel flow identifier from a data field list including a plurality of data field candidates; and
a message generation unit for generating a tunnel signaling message associated with the tunnel signaling flow and storing the tunnel flow identifier in the selected data field of the tunnel signaling message.

26. The apparatus of claim 25, wherein the tunnel signaling message comprises at least one of a quality-of-service (QoS) message, a network resource reservation message, and a network security message.
